(19) United States
(12) Patent Application Publication
(10) Pub. No.: US 2011/0060442 A1
(43) Pub. Date: Mar. 10, 2011

(54) METHODS AND ARRANGEMENT FOR DETECTING A WAFER-RELEASED EVENT WITHIN A PLASMA PROCESSING CHAMBER

(76) Inventors: John C. Valcore, JR., San Jose, CA (US); Mark Zerella, Berkeley, CA (US)

(21) Appl. No.: 12/557,381

(22) Filed: Sep. 10, 2009

(51) Int. Cl. G06F 19/00

(52) U.S. Cl. 700/103

(57) ABSTRACT

A method for identifying an optimal time for mechanically removing a substrate from a lower electrode in a processing chamber of a plasma processing system is provided. The method includes employing a set of sensors to monitor a set of electrical characteristics of a plasma, wherein the plasma is formed over the substrate during a dechuck event. The method also includes sending processing data about the set of electrical characteristics to a data collection device. The method further includes comparing the processing data against a set of threshold values. The method yet also includes, if the processing data traverses the threshold values, removing the substrate from the lower electrode since a substrate-released event has occurred.

### CROSS REFERENCE TO RELATED APPLICATIONS

The present invention is related to the following application(s), all of which are incorporated herein by reference:

Commonly assigned application entitled “Methods And Arrangement For Plasma Dechuck Optimization Based On Coupling Of Plasma Signaling To Substrate Position And Potential,” filed on even date herewith by Valcore et al. (Attorney Docket Number P1905/LMRX-P178).

### BACKGROUND OF THE INVENTION

Advances in plasma processing have provided for growth in the semiconductor industry. In order for the manufacturing company to be competitive, the manufacturing company needs to be able to maintain a high throughput while minimizing damage to the substrates being processed. Accordingly, the ability to remove a substrate from a lower electrode (such as an electrostatic chuck) without damaging the substrate while minimizing release-waiting time is essential for achieving a high throughput.

To elaborate, during substrate processing, a substrate is usually clamped to a lower electrode (such as an electrostatic chuck). Clamping may be performed by applying a direct current (DC) potential to the lower electrode to create an electrostatic clamping force between the substrate and the lower electrode. To dissipate the heat on the substrate during substrate processing, an inert gas (such as helium) may be applied through various channels in the lower electrode to the backside of the substrate to improve the thermal heat transfer between the substrate and the lower electrode. Consequently, due to the helium pressure on the substrate, a relatively high electrostatic charge is required to clamp the substrate to the lower electrode.

Once substrate processing has been completed within the processing chamber, the clamp voltage is turned off and the substrate is lifted from the lower electrode and removed from the processing chamber. In order to lift the substrate from the lower electrode without damaging the substrate, a dechucking event occurs in which the electrostatic charge on the substrate is discharged in order to remove the attraction force between the substrate and the lower electrode.

In most cases, discharging the electrostatic charge from the substrate is performed by generating a plasma to neutralize the electrostatic charge on the substrate. Once the electrostatic charge has been removed, the lifter pins disposed in the lower electrode may be employed to lift the substrate upward to separate the substrate from the electrostatic chuck surface, thereby allowing a robot arm to remove the substrate from the plasma processing chamber.

If the electrostatic charges are not satisfactorily removed from the substrate, part of the substrate may still be clamped to the lower electrode when the lifter pins try to lift the substrate up from the lower electrode. In this case, the substrate may break. Further, substrate debris may pollute the processing chamber, thereby requiring the processing chamber to be cleaned. Substantial amount of time and effort may be required to perform the chamber cleaning. In some instances, chamber cleaning may require the plasma processing system to be taken off line. As a result, unsatisfactory dechucking can be costly for the tool owner by increasing substrate waste and increasing tool ownership cost.

Since improper dechucking has such severe consequences, the dechuck event is usually executed for a specified time period, which tends to be fairly conservative in order to ensure sufficient time for the electrostatic charge to be sufficiently discharged such that the substrate becomes unclamped from the lower electrode. Given that the specified time period tends to be fairly long, the substrate is assumed to be unclamped from the lower electrode when the dechuck event has completed.

Accordingly, even if enough electrostatic charge has been sufficiently discharged before the end of the specified time period, the dechuck event is still executed for the entire time period. Thus, the remaining dechuck time period represents wasted time that may be applied toward achieving an increased throughput. Also, the existence of the plasma in the processing chamber for the additional time may also contribute to the premature degradation of the chamber components and or unwanted etching of the substrate.

On the other hand, the substrate is lifted up at the end of the specified time period even if the electrostatic charge has not been sufficiently removed from the substrate. Consequently, lifting the substrate when the electrostatic charge has not been satisfactory discharged may result in substrate breakage.

In view of the foregoing, there are desired improved techniques for detecting when the dechuck event is successful and for minimizing the time duration required to perform the dechucking step.

### BRIEF SUMMARY OF THE INVENTION

The invention relates, in an embodiment, to a method for identifying an optimal time for mechanically removing a substrate from a lower electrode in a processing chamber of a plasma processing system. The method includes employing a set of sensors to monitor a set of electrical characteristics of a plasma, wherein the plasma is formed over the substrate during a dechuck event. The method also includes sending processing data about the set of electrical characteristics to a data collection device. The method further includes comparing the processing data against a set of threshold values. The method yet also includes, if the processing data traverses the threshold values, removing the substrate from the lower electrode since a substrate-released event has occurred.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which;

FIG. 1 shows, in an embodiment of the invention, a simple block diagram of a dual frequency capacitively-coupled plasma processing system with two generator sources.

FIG. 2 shows, in an embodiment of the invention, an enlarged view of a plot of a plasma impedance (impedance magnitude per unit of time) versus time.

FIG. 3 shows, in an embodiment of the invention, a [FFT frequency spectrum plot] plot of a voltage signal at a higher sampling rate (at about 10 kilohertz).

FIG. 4 shows, in an embodiment of the invention, a plot of multiple electrical signals versus time.

FIG. 5 shows, in an embodiment of the invention, a simple flow chart illustrating the method for detecting the optimal time for safely separating the substrate from the lower electrode.

FIG. 6 shows, in an embodiment of the invention, a simple flow chart illustrating a theoretical method for detecting a substrate-release event.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

As aforementioned, the dechuck event based on a specified time period may not always provide the desired result. In some situations, the electrostatic charge may be sufficiently discharged before the end of the specified time period; thus, the remaining dechuck time is wasted since no beneficial etching is being performed on the substrate during this time. Further, the additional plasma-present time usually contributes to the premature degradation of the chamber component. In other situations, the electrostatic charge may not have been sufficiently discharged even after the entire specified time period has elapsed. As a result, partial sticking may occur causing the substrate to break when the lifter pins attempt to remove the substrate from the lower electrode.

Instead of relying on the specified time period for determining when a substrate may be removed from the processing chamber, a prior art method includes monitoring helium pressure and/or volume of helium gas. In an example, when a predetermined level of pressure is observed, the substrate is assumed to have been properly released. In another example, if a higher volume of helium gas has to be applied to maintain the same pressure, then the substrate is assumed to have been released.

However, since neither the helium flow nor the induced pressure accurately characterizes the actual electrostatic charges between the substrate and the lower electrode, the monitoring method based on mechanical values (such as helium flow) is insufficient in accurately identifying the optimal time for removing the substrate from the lower electrode. In an example, even though the pressure and/or flow indicate that a predetermined threshold value (the value that has been designated at which the substrate may be safely released from the lower electrode) has been met, the induced pressure and/or flow may not be consistent across the entire substrate surface. As a result, partial sticking may still occur resulting in a break in the substrate when the lifter pins try to push the substrate upward off the lower electrode.

In another example, a period of time may be required to allow the induced pressure and/or flow to reach the predetermined threshold value. However, the electrostatic charge that exists between the substrate and the lower electrode may have already been sufficiently discharged before the flow and/or pressure has reached the predetermined threshold value. As a result, throughput may be negatively impacted as precious time is wasted waiting for the predetermined threshold value to be reached. Consequently, neither helium flow and/or induced pressure may be sufficient in identifying the optimal time for safely releasing the substrate from the lower electrode.

In accordance with embodiments of the present invention, an innovative end point detection scheme for identifying an optimal time for mechanically removing a substrate from a lower electrode is provided. Embodiments of the invention include monitoring electrical characteristic of the plasma based on oscillations from the substrate for determining when the substrate may be safely separated from the lower electrode.

In this document, various implementations may be discussed using plasma impedance as an example. This invention, however, is not limited to plasma impedance and may include any electrical parameter that may exists during the dechuck event. Instead, the discussions are meant as examples and the invention is not limited by the examples presented.

In one aspect of the invention, the inventors herein realized that when the electrostatic charge is being removed from the processing chamber, substrate perturbations may occur. In other words, as the substrate is being released from the lower electrode, the substrate exhibits physical perturbations that causes oscillations in the dechuck plasma. The physical perturbations may exist as the inert gas (e.g., helium) is pushing the substrate off the lower electrode. Another reason for the physical perturbations may be due to the shifting of the substrate as the electrostatic charge is discharged. Accordingly, the inventors thereby realized that by measuring the electrical characteristics (e.g., plasma impedance, generator power, current, DC bias voltage, and the likes) of the plasma and comparing the electrical characteristics (e.g., plasma impedance, generator power, current, DC bias voltage, and the likes) to a set of threshold values, a determination may be made when the electrostatic charge has sufficiently discharged and the substrate may be lifted from the lower electrode.

In an embodiment of the invention, the set of threshold values may be determined theoretically. To determine the set of threshold values, a 3-D model of a substrate structure may be constructed. Given that the physical characteristics (thickness, size, material composition, etc.), of the substrate is a known factor, an oscillation frequency of the substrate may be constructed. By applying an analytical software, such as MATLAB (of The MathWorks, Inc. of Natick, Mass.), and a perfect tone to the 3-D model of the substrate, an oscillation frequency graph that characterizes the entire substrate may be created. The oscillation frequency graph may provide the set of threshold values from which comparison may be performed during substrate processing.

In another embodiment of the invention, a set of threshold values may be determined empirically. To determine the set of threshold values, a test substrate may be processed during a dechuck event. Physical perturbations exhibit by the substrate may be observed visually through a set of viewports by a process engineer.

At the same time, monitoring devices are capturing processing data about the electrical parameters. Empirically, the inventors have correlated that the electrical characteristic of the plasma change as each oscillation occurs. As a result, a set of threshold values may be determined by extracting the measurements of the electrical characteristics (e.g., plasma impedance, generator power, current, DC bias voltage, and the likes) at the time of each physical perturbation. In an example, plasma impedance may be monitored and a graph of the plasma impedance values matching the time of the physical perturbations of the substrate may be constructed as the set of threshold values.

Since different regions of a substrate may be released at different times, a broadband frequency analysis may be applied to the composite perturbations to create a set of threshold values that account for the different regions of the substrate. In an embodiment, since more than one electrical parameter may be employed to characterize the dechuck plasma, a library of electrical signatures may be employed as potential sets of threshold values. In an example, besides plasma impedance, electrical signatures may also be based off of DC bias, plasma voltage, current, and the likes. To minimize false positives during production, comparison may be made against more than one electrical signature.

The features and advantages of the present invention may be better understood with reference to the figures and discussions that follow.

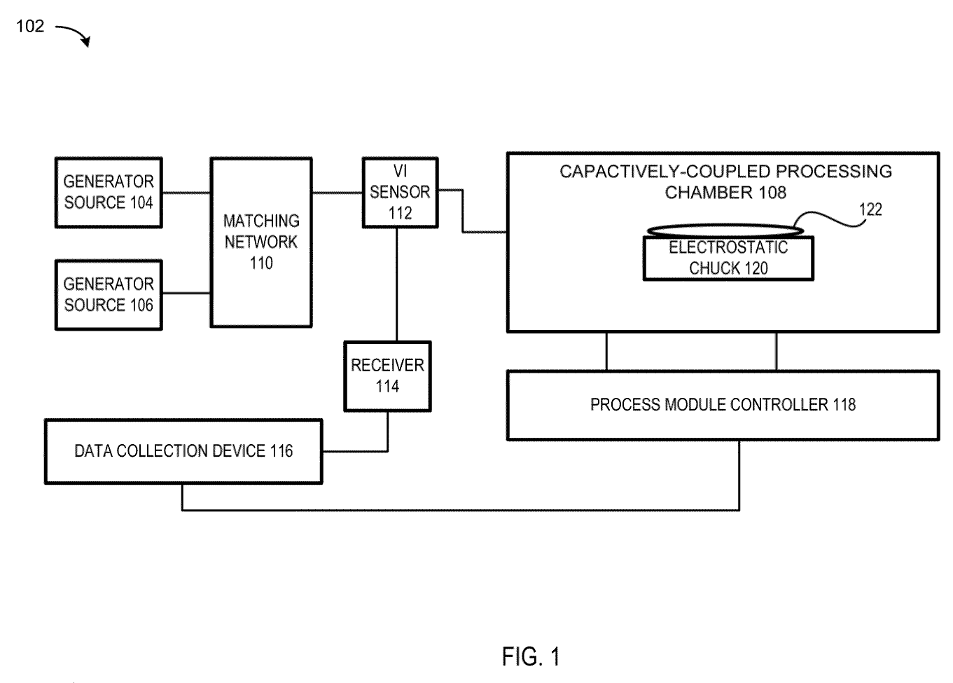

FIG. 1 shows, in an embodiment of the invention, a simple functional block diagram of a dual frequency capacitively-coupled plasma processing system with two generator sources. A processing system 102 includes two generator sources 104 and 106, which are configured to provide power to a capacitively-coupled processing chamber 108 via a matching network 110. Although a dual frequency capacitively-coupled plasma processing system is shown, the invention is not limited to this type of processing chamber. Instead, the inventive method discussed herein can be applied to any plasma processing system.

Capacitively-coupled processing chamber 108 may include a lower electrode 120 (such as an electrostatic chuck). During substrate processing, a substrate 122 is typically clamped to lower electrode 120. Clamping may be performed using electrostatic clamping, which involves creating an electrostatic charge to cause substrate 122 to be attracted to lower electrode 120 (such as an electrostatic chuck).

Consider the situation wherein, for example, substrate processing has been completed and a dechuck event is executed to remove the electrostatic force between substrate 122 and lower electrode 120. In most cases, discharging the electrostatic charge from substrate 122 is performed by generating a plasma for neutralizing the electrostatic charge on substrate 122.

Unlike the prior art, the dechuck event is not executed for a predetermined specified time period. Instead, the dechuck event is executed until a set of electrical characteristics (e.g., plasma impedance, generator power, current, DC bias voltage, and the likes) within the processing chamber has met a set of threshold values. In an embodiment, the comparison is performed by an algorithm that compares processing data of one or more electrical parameters against a set of electrical signatures to determine the optimal time for removing substrate 122 from lower electrode 120.

In order to have sufficient data to analyze the plasma, sensors may be employed to collect processing data about each substrate. In an example, a voltage current sensor 112 may be employed to capture processing data relating to the dechuck event (such as DC bias, plasma impedance, current, plasma voltage, and the likes). The processing data may be converted from its analog format into a digital format by a receiver 114. Once the data has been converted, the digital data may be forwarded to a data collection device 116 for analysis. In an embodiment, the data collection device 116 may be configured not only to receive the digital data but also to perform the comparison algorithm to determine the optimal release time. The data collected may be analyzed in order to determine when the substrate can be lifted from the electrostatic chuck and remove from the processing chamber.

Once the optimal release time has been identified, in an embodiment, a message may be sent to a process module controller 118. Upon receiving the message, process module controller 118 may instruct a pneumatic lift assembly to raise the lifter pins, which are disposed in lower electrode 120, to move substrate 122 upward to separate substrate 122 from lower electrode 120, thereby allowing a robot arm to remove substrate 122 from the plasma processing chamber. By monitoring the actual electrical parameters associated with driving the dechuck plasma, the optimal time for releasing substrate 122 may be determined and substrate 122 may be lifted from lower electrode 120 without damaging substrate 122.

As aforementioned, the discharge of the electrostatic charge between substrate 122 and lower electrode 120 is reflected by the physical perturbations of substrate 122. Each physical perturbation causes an oscillation in the dechuck plasma. By comparing the oscillation frequency of substrate 122 against a predetermined oscillation frequency that has been established to be indicative of the optimal time for safely lifting a substrate from the lower electrode, a determination can be made of when a sufficient amount of electrostatic charge has been removed to safely lift substrate 122 from lower electrode 120.

Correspondingly, the oscillation in the dechuck plasma affects the plasma electrical characteristics (e.g., plasma impedance, generator power, current, DC bias voltage, and the likes), which is detectable by the sensor(s). Since the electrical characteristics of the de chuck plasma is affected by the oscillation, the electrical characteristics may also be included as part of the end-point detection scheme for separating the substrate from the lower electrode.

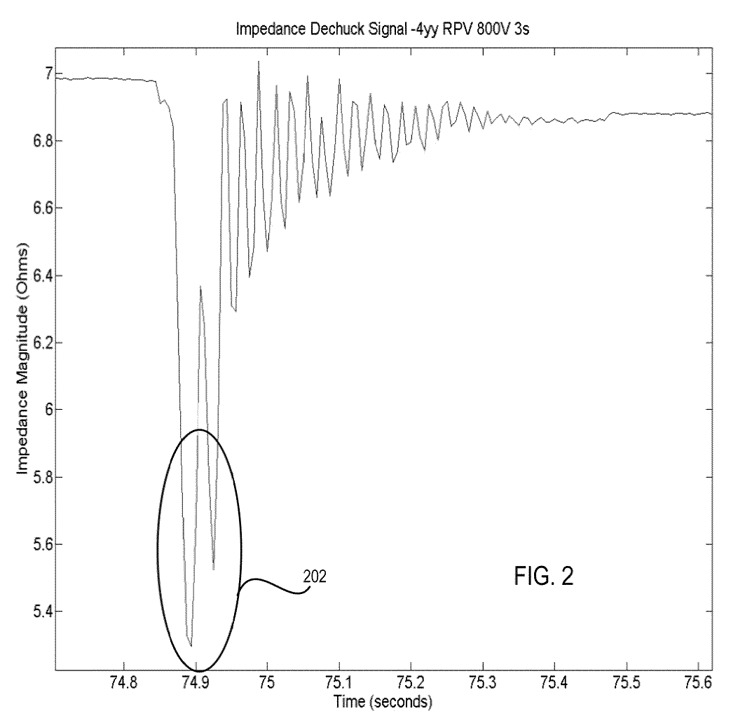

As aforementioned, the physical perturbations exhibit by the substrate during the dechuck event may be visually monitored in a test environment. At the moment a physical perturbation is exhibited by the substrate, a corresponding perturbation may be seen in the electrical parameters of the plasma. FIG. 2 shows, in an embodiment of the invention, an enlarged view of a plot of a plasma impedance (impedance magnitude per unit of time) versus time. In FIG. 2, the plasma impedance signal shows a perturbation in the plasma impedance signal corresponding to the moment in time when a physical perturbation of a test substrate causes an oscillation in the plasma. As can be seen at point 202, a strong change in the impedance signal occurs as the substrate moves. In this example, even though the plot is of a low sampling rate (about 175 hertz), a strong change from 7 ohms to less than 5.4 ohms occur during the time period between 74.8 seconds to 75 seconds.

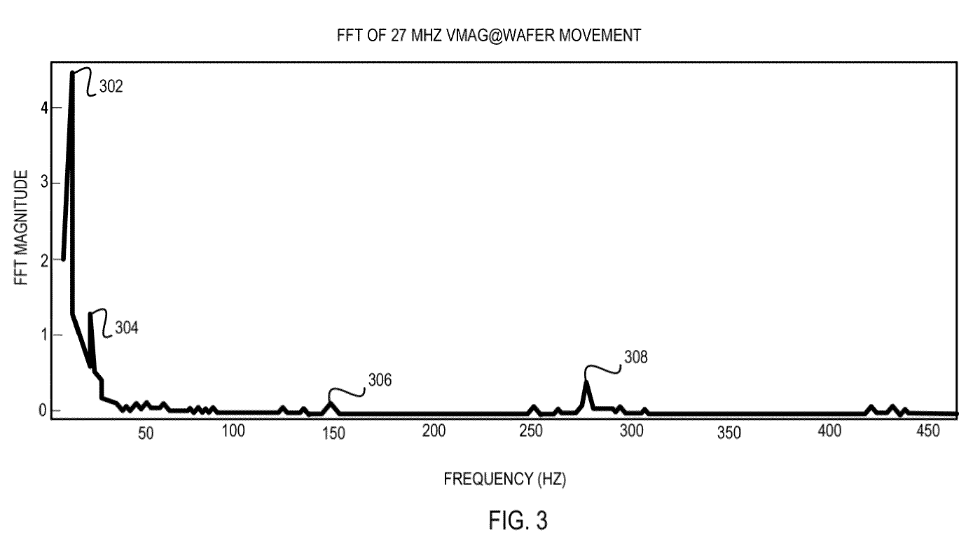

FIG. 3 shows, in an embodiment of the invention, a FFT (Fast Fourier Transform) of a 27 megahertz voltage signal. The plot is shown at a higher sampling rate (at about 10 kilohertz) in comparison to FIG. 2 and is a broadband frequency composite frequency indicative of substrate movements after the clamp voltage is initially turned off. In an example, each of the perturbations (point 302, 304, 306, 308, etc.) in the voltage signals corresponds to an oscillation in the plasma as the substrate moves after the clamping voltage is initially turned off.

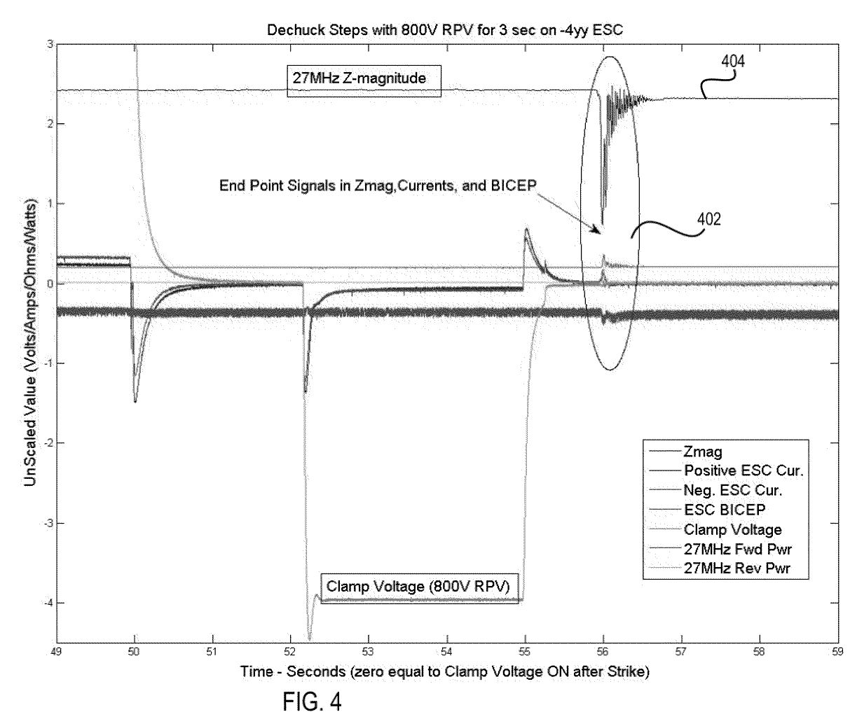

As aforementioned, the oscillation into the plasma during the dechuck event may affect more than one electrical signals. FIG. 4 shows, in an embodiment of the invention, a plot of multiple electrical signals versus time. At point 402 (around 56 seconds), each of the electrical signals shows a perturbation. Thus, an oscillation in the plasma is reflected by a harmonic change in each of the electrical signal. Although each electrical signals exhibit a perturbation, the magnitude of each perturbation varies. In this example, the 27 megahertz plasma impedance (line 404) has a significantly greater magnitude than the other electrical signals. In an embodiment, the determination of an optimal time for separating a substrate from a lower electrode may be based on the electrical signal with the greatest perturbation.

In an embodiment, the innovative end point detection scheme may also minimize the potential of substrate breakage due to partial sticking by substantially eliminating false positives. In an example, at around 50 seconds, some of the electrical signals show perturbations. However, at that moment in time, not all regions of the substrate have been completely released. Thus, the comparison algorithm may be based on more than one electrical signal, in an embodiment.

As can be appreciated from the foregoing, the comparison algorithm for detecting the release event may be configured to account for the behavior of the different electrical signals. In an example, for an electrical signal that may be significantly affected by an oscillation in the plasma, the comparison algorithm may make a determination that if the perturbation in the electrical signal meets the threshold value, a substrate-released event has occurred and the substrate may be safely removed. However, for electrical signals that may not exhibit a large change due to an oscillation into the plasma, the comparison algorithm may also require additional electrical signals to exhibit similar behavior before the comparison algorithm may identify the perturbation as a released event.

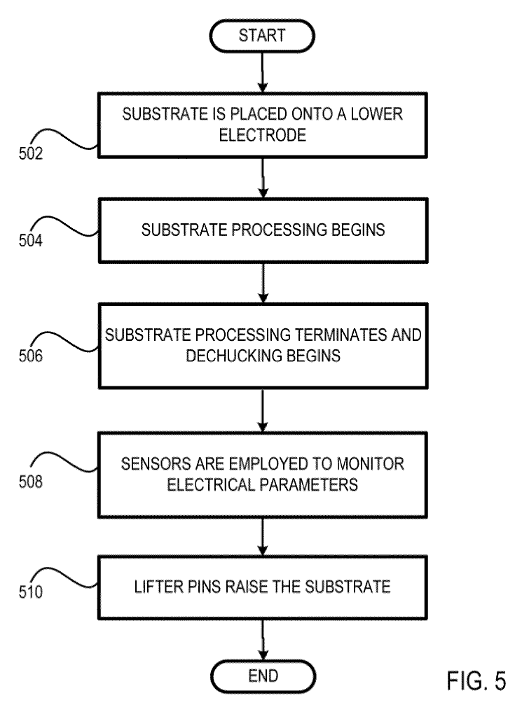

FIG. 5 shows, in an embodiment of the invention, a simple flow chart illustrating the method for detecting the optimal time for safely separating the substrate from the lower electrode.

At a first step 502, a substrate is placed onto a lower electrode. In an example, substrate 122 is positioned on top of lower electrode 120 (such as electrostatic chuck). To hold substrate 122 in place, a clamp voltage is employed to create an electrostatic charge between substrate 122 and lower electrode 120.

At a next step 504, substrate processing is executed. In an example, substrate 122 is processed in processing chamber 102. During substrate processing, an inert gas (such as helium) may be employed to cool the backside of substrate.

At a next step 506, substrate processing is completed and the dechuck event is executed. When substrate processing has completed, the power from generator sources 104 and 106 are ramped down from the main etch level to a level that is sufficient to maintain a low-powered plasma. The plasma is strong enough to neutralize the electrostatic charge on substrate 122 but is too weak to perform etching. Also, processing chamber 108 is vacated by pumping out the Helium (wafer backside inert gas) pressure. Generally, the Helium (wafer backside inert gas) pressure in processing is about 20-30 torrs. However, the amount of Helium (wafer backside inert gas) pressure after processing in a chamber is a low-level pressure of about 2-3 torrs. Additionally, the clamp voltage that is maintaining the electrostatic force between substrate 122 and lower electrode 120, is turn off.

During the dechuck event, substrate 122 may move. In an example, when the clamp voltage is turned off, substrate 122 may flex back to its natural state. In another example, the backside inert gas flow may cause substrate to be lifted up since the clamping voltage is no longer on to maintain the electrostatic force (the force that clamped substrate 122 to lower electrode 120). The substrate movement may cause oscillations in the plasma that may be reflected as changes in the electrical characteristics of the parameter.

At a next step 508, sensors are employed to monitor the electrical parameters (signals) of the plasma. In an example, electrical parameters such as plasma impedance, DC bias voltage, current, generator power, and the likes may be monitored since these electrical parameters are affected while the electrostatic charge is being discharged. In an example, a voltage and current sensor may be employed to capture processing data. The processing data (such as plasma impedance) may be sent to the data collection device for analysis. The processing data is compared against a threshold value. If the processing data traverses the threshold value, then the electrostatic charge is considered to be sufficiently charged. However, if the threshold value is not met, then the substrate-released event has not happened and the dechuck event continues.

As discussed herein, the term traverse may include exceed, fall bellow, be within range, and the like. The meaning of the word traverse may depend upon the requirement of the threshold value/range. In an example, if the recipe requires the plasma impedance, for example, to be at least a certain value, then the processing data is considered to have traversed the threshold value/range if the plasma impedance value has met or exceed the threshold value/range. In another example, if the recipe requires the plasma impedance, for example, to be below a value, then the processing data has traversed the threshold value/range if the plasma impedance value has fallen below the threshold value/range.

In an embodiment, only one electrical parameter is monitored. If only one electrical parameter is being monitored, the electrical parameter that is monitored has been determined empirically to exhibit the greatest change when a substrate exhibits physical perturbations.

In another embodiment, multiple electrical signals may be monitored. By monitoring more than one signal, false positive may be significantly eliminated. In an example, conditions may be set in which a combination of signals may have to pass a set of threshold values before substrate 122 is considered to be sufficiently released to ensure a safe release from lower electrode 120.

At a next step 510, the lifter pins raise the substrate from the lower electrode. In an example, the conditions for a substrate-released event has been met (such as one or more electrical signals has met the set of threshold values), a message is sent to the process module controller 118 to instruct the pneumatic lift assembly to raise the lifter pins in order to separate substrate 122 from lower electrode 120, thereby allowing substrate 122 to be available for removal from processing chamber 102 by a robot arm.

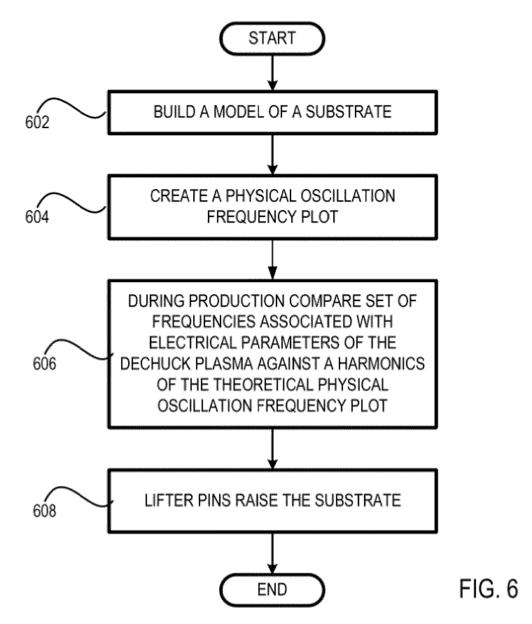

FIG. 6 shows, in an embodiment of the invention, a simple flow chart illustrating a theoretical method for detecting a substrate-release event.

At a first step 602, a model of the substrate is constructed. In an embodiment, the model is a 3-D model that captures the physical characteristics (such as thickness, size, and material composition) of the substrate, including the differences that may exist between the different regions of the substrate.

At a next step 604, a physical oscillation frequency plot is determined for the substrate model when the substrate is physically perturbed by a substrate-released event. In an embodiment, an analytical program, such as MATLAB (of The MathWorks, Inc. of Natick, Mass.), in conjunction with a perfect tone may be applied to the model to plot the oscillation frequency of a released event.

At a next step 606, an algorithm may employ one of the harmonics of the physical oscillation frequency plot as an electrical signature to compare against the actual oscillation frequency of a substrate during a dechuck event in production.

At a next step 608, the lifter pins raise the substrate from the lower electrode. In an example, once one or more electrical signals has met the electrical signatures, a substrate-released event is identified and a message is sent to the process module controller 118 to instruct the pneumatic lift assembly to raise the lifter pins in order to remove substrate 122 from lower electrode 120.

As can be appreciated from FIGS. 5 and 6, the innovative end point detection scheme allows proper dechucking of the substrate from the lower electrode in a safe and efficient manner. The method substantially eliminates the potential for false positives, thereby removing the potential for partial sticking that can result in damage to the substrate. The method also provides for high process yield and system throughput since the substrate is removed from the processing chamber once the optimal time for removal has been identified. In other words, once one or more electrical signals provides evidence that the electrostatic charge has been sufficiently discharged, the substrate is separated from the lower electrode. Unlike the prior art, time is not wasted because a specified time wait period has not elapsed.

As can be appreciated from one or more embodiments of the present invention, an innovative end point detection scheme during dechucking is provided. With the innovative end point detection scheme, methods are provided for accurately identifying a substrate-released event in a safe and timely manner. Thus, less substrate is wasted due to partial sticking and less time is required for chamber cleaning, thereby reducing the cost of ownership. Also, since the substrate is removed from the processing chamber when a substrate-released event has been positively identified, higher throughput may be achieved.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for identifying an optimal time for mechanically removing a substrate from a lower electrode in a processing chamber of a plasma processing system, comprising:
employing a set of sensors to monitor a set of electrical characteristics of a plasma, wherein said plasma is formed over said substrate during a dechuck event;
sending processing data about said set of electrical characteristics to a data collection device;
comparing said processing data against a set of threshold values; and
if said processing data traverses said threshold values, removing said substrate from said lower electrode since a substrate-released event has occurred.

2. The method of claim 1 wherein if said processing data does not traverse said set of threshold values, said substrate-released event is deemed to have not occurred and said substrate is not removed from said lower electrode.

3. The method of claim 2 wherein said set of electrical characteristics includes plasma impedance.

4. The method of claim 2 wherein said set of electrical characteristics includes direct current bias voltage.

5. The method of claim 2 wherein said set of electrical characteristics includes current generator power.

6. The method of claim 2 wherein said set of electrical characteristics is a single electrical parameter, wherein said single electrical parameter has been empirically determined to exhibit the greatest change when a test substrate exhibits physical perturbations during a dechuck event.

7. The method of claim 2 wherein said set of electrical characteristics includes more than a single electrical parameter, wherein a combination of electrical parameters is compared against a plurality of threshold values to determine said substrate-released event.

8. The method of claim 1 wherein said plasma processing system is a dual frequency capacitively-coupled plasma processing system.

9. A method for identifying an optimal time during a dechuck event for mechanically removing a substrate from a lower electrode in a processing chamber of a plasma processing system, comprising:
generating an oscillation frequency plot of a set of electrical characteristics for said substrate during said dechuck event;
comparing said oscillation frequency plot of said substrate against a set of electrical signatures; and
if said oscillation frequency plot traverses said set of electrical signatures, removing said substrate from said lower electrode since a substrate-released event has occurred.

10. The method of claim 9 wherein if said oscillation frequency plot does not traverse said set of electrical signatures, said substrate-released event is deemed to have not occurred and said substrate is not removed from said lower electrode.

11. The method of claim 10 wherein said set of electrical characteristics includes plasma impedance.

12. The method of claim 10 wherein said set of electrical characteristics includes direct current bias voltage.

13. The method of claim 10 wherein said set of electrical characteristics includes current generator power.

14. The method of claim 10 wherein said set of electrical characteristics is a single electrical parameter, wherein said single electrical parameter has been empirically determined to exhibit the greatest change when a test substrate exhibits physical perturbations during a dechuck event.

15. The method of claim 10 wherein said set of electrical characteristics includes more than a single electrical parameter, wherein a combination of electrical parameters is compared against a plurality of threshold values to determine said substrate-released event.

16. The method of claim 9 wherein said plasma processing system is a dual frequency capacitively-coupled plasma processing system.

17. The method of claim 9 wherein said set of electrical signatures is a set of physical oscillation frequency plots of a substrate model, wherein said set of physical oscillation frequency plots is generated when said substrate model is physically perturbed by a substrate-released event.

18. The method of claim 17 wherein said oscillation frequency plot is compared against a harmonics of said set of physical oscillation frequency plots.

19. An article of manufacture comprising a program storage medium having computer readable code embodied therein, said computer readable code being configured for identifying an optimal time during a dechuck event for mechanically removing a substrate from a lower electrode in a processing chamber of a plasma processing system, comprising:
code for employing a sensor to monitor a set of electrical characteristics of a plasma, wherein said plasma is formed over said substrate during a dechuck event;
code for sending processing data about said set of electrical characteristics to a data collection device;
code for comparing said processing data against a set of threshold values; and
code for removing said substrate from said lower electrode if said processing data traverses said threshold values, since a substrate-released event has occurred.

20. The article of manufacture of claim 19 wherein said set of electrical characteristics includes one of plasma impedance, direct current bias voltage, and current generator power.
